(19) United States
(12) Patent Application Publication
(10) Pub. No.: US 2008/0154018 A1
(43) Pub. Date: Jun. 26, 2008

(54) Process for the filtration of molten polycarbonate

(76) Inventors: Wolfgang Ebert, Krefeld (DE); Bernhard Nietzwetzki, Duisburg (DE); Rainer Mellis, Baytown, TX (US); Wilfried Haese, Odenthal (DE); Bert Ruytinx, Halen (BE); Alexander Karbach, Krefeld (DE); Alexander Meyer, Dusseldorf (DE)

Correspondence Address: CONNOLLY BOVE LODGE & HUTZ, LLP, P O BOX 2207, WILMINGTON, DE, 19899, US

(21) Appl. No.: 11/977,505

(22) Filed: Oct. 25, 2007

(30) Foreign Application Priority Data
Oct. 31, 2006 (DE) 102006051305.3

(51) Int. Cl. C08G 64/30; B01D 39/10

(52) U.S. Cl. 528/370

(57) ABSTRACT

A process for purifying polycarbonate is disclosed. The process entails filtering molten polycarbonate having weight average molecular weight of 14,000 to 30,000 g/mol through at least one non-woven metal structure having a thickness of 5 to 1 mm, said structure including at least one dense layer, and at least one less dense layer wherein said dense layer is 0.05 to 0.2 mm thick and has pore size of 1 to 10 μm to obtain pure polycarbonate.

### FIELD OF THE INVENTION

The invention relates to a process, and more particularly to the filtering of molten polycarbonate resin.

### TECHNICAL BACKGROUND OF THE INVENTION

The transparent injection molded items may be e.g. transparent sheets, lenses, optical storage media, or else articles for the automotive glazing field such as e.g. scattered light windscreens, for which high optical quality is required. Furthermore, this process is suitable for substrate materials from which extruded films in which a low-defect surface is important are produced.

Transparent injection molded items are of importance in particular in the glazing and storage media fields.

Optical data recording materials have recently been used to an increasing extent as a variable recording and/or archiving medium for large volumes of data. Examples of this type of optical data store are e.g. CD, super-audio-CD, CD-R, CD-RW, DVD, DVD-R, DVD+R, DVD-RW, DVD+RW and BD.

Transparent thermoplastic materials, such as for example, polycarbonate and chemical modifications thereof, are typically used for optical storage media. A substrate material that is suitable in particular for write-once-read-many times and also for write-many times optical discs is primarily aromatic polycarbonate, in particular polycarbonate based on bisphenol A. Polycarbonate is also suitable for the production of molded items for the automotive glazing field, such as e.g. for scattered light windscreens. This thermoplastic material has exceptional mechanical stability, is less susceptible to changes in dimensions and is characterized by high transparency and impact resistance.

In order to store larger volumes of data on a data carrier, formats such as the DVD were developed after CDs. These enable, for example, the storage of feature films as a result of the increased storage capacity. Thus, a DVD has 6-8 times the take-up capacity of a CD. This was made possible by the use of smaller pits, smaller track spacings and a reduction in the laser wavelength from about 780 nm to about 655 nm for DVDs. Furthermore the numerical aperture for the optical readout system was increased.

The development of new formats such as e.g. HD-DVD (high density DVD) or the so-called blu-ray disc (BD) again operate with shorter laser wavelengths. In the case of a BD, readout takes place through a transparent cover material (e.g. a PC film).

This means that the requirements placed on the substrate through which the radiation passes or the cover material through which the radiation passes are increasingly stringent. The higher the storage density of the particular medium, the higher are the requirements (e.g. lower particle contents) placed on the quality of the substrate material. Defects in the substrate layer through which radiation is transmitted and in the cover material through which radiation is transmitted lead to errors in the readout process.

Thus, defects, in particular those that can interact with the laser beam of the readout system, are of particular relevance with regard to an error-free readout process. These include, as is well-known, foreign particles such as e.g. dust particles or metal particles that can absorb and/or scatter the laser beam. As a result of lowering the wavelength of the readout laser, those particles, the absorption or fluorescence of which lies within the wavelengths of the laser used, can also cause problems. In the case of a HD-DVD (high density DVD) or blu-ray disc, for example, these are wavelengths between 400 nm and 410 nm.

High-quality extruded films for which these substrate materials are also suitable are used primarily in the electronics sector, for decorative and functional blinds in the domestic sector and as covering films, e.g. for sports items, for ID cards and for blister packs. Other areas of application are in the field of automobile construction, e.g. as bodywork parts or external mirrors, or in the field of telecommunication such as e.g. palm-top cases and palm-top keyboards. The films are characterized by high transparency, impact resistance and thermal stability. Another critical quality feature is the surface quality of the film. In particular in the case of high-quality housing and display covers, imperfections in the surface that lead to increased rates of rejection, are very noticeable.

The melt filtration of polymers is known in principle and is described, for example, in EP-A 0806281 and EP-A 0220324. The melt filtration of polycarbonate in particular is also described, for example, in EP-A 1199325. The filtration of highly viscous polymer melts is quite a critical process because high pressures are often used and the shear forces in the filter can lead to shear heating that can then result in thermal decomposition of the polycarbonate. Depending on the time of residence in the filter and the temperature of the polymer melt, interaction with the large metal surfaces can also result in damage to the polycarbonate. Depending on the pressure and throughput, there is a risk that fluorescent particles are forced through the filter medium or are generated due to the factors mentioned above.

The object of the invention was therefore to provide a process for the filtration of polymer melts, in particular polycarbonate melts, that enables the separation of fluorescent particles from polycarbonate and thus to obtain a substrate material with a low fluorescent particle content.

JP 04-342760 (1992) describes a melt filtration process for highly viscous polycarbonate. The melt filtration process described therein is performed using filter media with a pore size of 20 μm. The filter medium is not specified in any more detail. The retention of fluorescent particles is not mentioned.

EP-A 1156071 describes a passivation process for filter media, using weak acids such as e.g. phenol. This achieves an improvement in the yellowness index of the filtered material. Fluorescent particles are not described. This method and a filtration process using these types of pretreated filters is not suitable for a reduction in the number of fluorescent particles.

JP 2001310935 describes a melt filtration process for the removal of impurities in polycarbonate. The separation of fluorescent particles is not described. The temperature of the melt that is passed through the filter is 280 to 340° C. Melt filtration is performed using filters with a pore size of 0.5 to 50 μm. The filter medium is not specified precisely. Thus, for example, the thickness of the filter medium is not described. However, the particle content also depends on the concentration of free bisphenol. In contrast to that, in the process according to the invention described here, the bisphenol content is of lesser importance. Pretreatment of the filter media is not described.

EP-A 1199325 describes a melt filtration process. Melt filtration is performed through filter media with a pore size ≦40 μm. However, nothing is said with regard to the thickness of the filter layer, which is a critical quantity in order for the particles described here to be retained. There is no method reported that retains fluorescent particles with specific viscous properties. The filter media are not pretreated.

JP 2003048975 describes the production of polycarbonate in a melt transesterification process. In this process the molten raw materials are subjected to filtration through a passivated filter. There is no mention of the formation and separation of fluorescent particles. The method according to the invention differs from that described in JP2003048975 because in the Japanese document the raw materials and not the polymer melts are filtered.

None of the documents mentioned above describe the filtration process according to the invention nor do they mention the concentration of fluorescent particles in the polycarbonate. The methods mentioned above do not lead to an effective reduction in the number of fluorescent particles in polycarbonate.

It is known that substrate materials for optical data storage contain impurities in form of particles. EP-A 379130 states, for example, that these impurities can have a negative effect on writing to or reading from an optical data carrier using a laser beam. A substrate material has good quality when the content of such impurities (particle index), as described in this patent, lies below a certain value. The impurities may be dust or charred material or metal abrasion. These impurities, that are clearly differentiated from the substrate material, are detected in a solvent in which the substrate material itself is soluble. These impurities that can be detected in this solvent are not the object of the present invention. The impurities described here cannot be detected in a solvent in which the substrate material is soluble because they have a similar refractive index to that of the polycarbonate solution being measured. Thus, these impurities are not detected, for example, by the Hiac Royco test in accordance with the prior art, as described e.g. in DE 102 48 951.

JP-A-020135222 describes impurities with a gel-like character that have a refractive index different from that of the matrix. These impurities can also reduce the quality of the optical data store. These impurities can be greatly reduced in an extrusion process, for example, by adding water. These impurities differ from the ones described here because the refractive index of the impurities described here does not differ substantially from that of the matrix. Furthermore, the impurities described here cannot be removed, nor their concentration lowered, in an extrusion process by the addition of water.

### SUMMARY OF THE INVENTION

A process for purifying polycarbonate is disclosed. The process entails filtering molten polycarbonate having weight average molecular weight of 14,000 to 30,000 g/mol in through at least one non-woven metal structure having a thickness of 5 to 1 mm, said structure including at least one dense layer, and at least one less dense layer wherein said dense layer is 0.05 to 0.2 mm thick and has pore size of 1 to 10 μm to obtain pure polycarbonate.

### DETAILED DESCRIPTION OF THE INVENTION

It was found that substrate materials, in particular substrate materials based on polycarbonate, contain impurities in the form of particles that exhibit fluorescence within the critical absorption spectrum described above for a blue laser (400 to 410 nm). Surprisingly, it was found that a large proportion of these fluorescent particles had different rheological properties from those of the polymer matrix (polycarbonate) itself. These defects found in substrate materials can lead to surface defects in the final injection molded part such as, for example, an optical disc. Thus, the rheological properties of these impurities differs from that of the polymer matrix.

The fluorescent particles in granules and the fluorescent elongated particles in injection molded items are characterized by the following properties:

Measurements of the mechanical properties of the particles produce a higher modulus and a greater hardness that those of the matrix material (polycarbonate). The hardness of the particles is up to about 0.3 GPa higher than that of the matrix. The values for hardness were determined using a nanoindenter made by Hysitron on one disc surface and over one cross section of the disc (particles vs. matrix). Depending on the position of the fluorescent particles in the injection molded item, flow distortions, and thus defects in the surface of the injection molded item, are initiated. This applies in particular below certain cycle times, mainly below 3.5 and in particular below 3 seconds. These elongated particles, which fluoresce of themselves, are relevant not only for optical data stores through which a blue laser beam passes, but also for other injection molded items such as e.g. lenses or light-scattering windscreens, because these surface defects, caused by the elongated particle, generally reduce the optical quality of the surface. In the case of optical data stores, these surface defects are detected by a scanner during the production process. The faulty discs are rejected.

The optical defect on an injection molded item can, in the case of a disc, reach a length of several millimetres. The defect is oriented in the direction of flow, i.e. in the case of optical discs for optical data carriers they are oriented radially. There is an elongated fluorescent particle within this optical defect. It was found that the fluorescent elongated particle, e.g. on discs, has a length/width ratio of 2-30, on average of 5-15. The length of the fluorescent elongated particle is between 10 and 200 μm. These values depend strongly on the process during injection molding, in particular on the cycle time.

It was also found that the fluorescent elongated particles exhibit relaxation behaviour. After these fluorescent particles have been conditioned for 2 minutes at 300° C., the length/width ratio is found to be about 1, i.e. the elongated fluorescent particle relax to yield a spherically shaped distortion; i.e. these fluorescent particles can be thermoplastically deformed, but do not have sufficient solubility in the polymer matrix.

The fluorescent elongated particles exhibit a certain swelling behavior. If these elongated particles are treated with dichloromethane for 5 minutes, then the area of the fluorescent region increases. The increase in volume of the defect was determined from that—giving the factor 1.1 to 3.5 (the spherical volume of the defect was determined from the radius of the circle with equivalent area). On average, an increase by a factor of about 2 was obtained. The polymer matrix itself dissolves completely in the case of polycarbonate, whereas the fluorescent body remains undissolved.

Furthermore, it was found that the fluorescent particles take on certain color indices. For this purpose, the particles were irradiated with light from a mercury vapour lamp through a step filter with a passage from 470 nm upwards. The color of the particles was determined using a digital color camera, a Zeiss Axiocam HRc, incorporated in a Zeiss Axioplan microscope, using the HSI (hue, saturation, intensity) color model. The method is described in e.g. “Digitale Bildverarbeitung mit dem PC”, Hans-Jürgen Schlicht, Addison-Wesley, 1993. If the color of the fluorescing particles is measured at a given setting for the illumination, then the following values are found: the hue value is on average about 80° C., the color saturation is on average about 150 digits and the color intensity is on average about 190 digits. The color of the matrix, in the case of polycarbonate, is given by a hue value of about 75°, a color saturation of on average 133 digits and a color intensity of on average 36 digits. When considering the data on the correct color site of the particles and the matrix, the values for hue, saturation and intensity have to be combined. In this way, only particles with a characteristic color are counted, i.e. other particles, such as e.g. dust, are not taken into account.

The larger the number of fluorescent particles of a certain size in the polymer granules, the greater is the probability of obtaining surface defects in the final injection molded item. This raises the rate of rejection of the particular product.

Surprisingly, it was found that not all fluorescent particles lead to surface defects, but only particles of a certain size. Fluorescent particles that lay below the surface defects were prepared from optical discs by microtome and relaxed in the melt as described above. Only spherical particles with a diameter of >10 μm were found.

Starting from the prior art, there is thus the object of separating out the problematic particles described above and thus providing an ultrapure substrate material, preferably made of polycarbonate, that is suitable for the production of data carriers, in particular those data carriers that are read with blue laser light, as well as for the production of high-quality optical injection molded items and high-quality extrusion molding compounds.

The object is achieved by providing a special melt filtration process, preferably for separating out the fluorescent particles. This is particularly surprising because particles with the viscous properties described above can be separated out only with great difficulty because they can be deformed as a result of their properties. Using the filtration process it is possible to obtain a substrate material that is suitable for the production of data carriers, in particular those data carriers that are read with blue laser light, as well as for the production of high-quality injection molded articles.

The invention provides a process for the filtration of polycarbonate, characterized in that the melt of polycarbonate having molecular weight (weight average) of 14,000-30,000 g/mol, preferably 15,000-29,000 g/mol and particularly preferably 16,000-22,000 g/mol (determined by gel permeation chromatography) is filtered though at least one metal non-woven structure consisting of more than one layer (stratum) of thin metal wires. The wires are stapled to give layers and may optionally be stabilized by thicker supporting wires. The metal non-woven structure consists of wires of e.g. V4A steel, e.g. with the material number 1.4571. The supporting wires may consist of e.g. V4A 1.4571 or V2A 1.4541 or steel with the material number 1.4310. The non-woven structure has a thickness of 5 mm to 0.1 mm, preferably 1 mm to 0.2 mm. The non-woven structure is built up from alternating layers of different density (i.e. with different pore sizes). The densest layer is preferably located in the middle of the non-woven structure. The densest layer is preferably 0.05 to 0.2 mm thick. Furthermore, the densest layer preferably consists of thin wires with a diameter of 1-20 μm, preferably 2-10 μm, particularly preferably 2-7 μm. The less dense layer is preferably 0.05 to 0.3 mm thick. The wires in this layer have a diameter of 1-20 μm, preferably 2-10 μm, particularly preferably 2-7 μm. The pore size in the less dense layers is preferably 20-60 μm, that in the densest layer preferably 1-10 μm. These wires may be smooth or have a surface structure that can be achieved by special methods of treatment such as by treating with acid such as e.g. nitric acid or citric acid or by electropolishing. There are preferably 2 to 10, particularly preferably 2 to 8 and in particular 2 to 6 layers. Other support gratings, perforated sheets, expanded metal or similar materials that are used to support the non-woven structure may be attached to the front and rear faces of the metal non-woven structure.

The filtration process is generally performed under pressure, preferably at pressures of 5 to 35 bar, in particular at 10 to 30 bar.

The filter non-woven structure and all metal surfaces of the filter may be thermally pretreated. Thermal pretreatment may take place in a protective gas atmosphere such as nitrogen or argon or in an oxidative atmosphere such as air, preferably in an oxidative atmosphere.

Thermal pretreatment is generally performed at temperatures of 200 to 1200° C., depending on the type of conditioning and the corresponding conditioning temperature. The duration of thermal pretreatment is generally 1 minute to 48 hours, preferably 2 minutes to 30 hours and in particular 10 minutes to 24 hours and depends on the type of conditioning.

Thermal pretreatment may take place by annealing the metal surface in a flame, by conditioning in a muffle furnace or in a fluidised bed or by conditioning in a circulating air oven.

When annealing the metal surface in a gas flame, the temperature is generally between 600 and 1500° C., preferably between 800 and 1200° C., when conditioning in a muffle furnace the temperature is between 300 and 1000° C., preferably between 600 and 900° C. and when conditioning in a circulating air oven, the temperature is 200 to 500° C., preferably 300 to 400° C.

The duration of thermal pretreatment at temperatures above 600° C. is generally 1 minute to 1 hour, in the temperature range 300 to 700° C. it is generally 30 minutes to 48 hours, preferably 30 minutes to 30 hours, in particular 2 to 25 hours, at temperatures of 300 to 500° C. the duration is generally 1 to 48 hours, preferably 2 to 30 hours, in particular 4 to 25 hours. Flaming the metal parts treated by annealing may take place in a sand or fluidised bed.

The metal surfaces in the filter non-woven structure are particularly preferably conditioned at 200 to 500° C., preferably 250 to 450° C., in particular 300 to 400° C., for up to 35 hours, preferably 4 to 30 hours, in particular 8 to 26 hours. A temperature of 350° C. and a period of 24 hours is very particularly preferred.

Using this method of filtration, the number of fluorescent particles with a particle diameter of 5-250 μm in polycarbonate is greatly reduced. In particular, the number of particles that have a particle diameter greater than 50 μm is greatly reduced.

The polycarbonate according to the invention is produced, inter alia, using the phase interface process. Many variants of this process for synthesising polycarbonate have been described in the literature; for example reference may be made to H. Schnell, Chemistry and Physics of Polycarbonates, Polymer Reviews, vol. 9, Interscience Publishers, New York 1964, p. 33 et seq., to Polymer Reviews, vol. 10, “Condensation Polymers by Interfacial and Solution Methods”, Paul W. Morgan Interscience Publishers, New York 1965, chap VIII, p. 325, to Dres. U. Grigo, K. Kirchner and P. R. Müller “Polycarbonate” in Becker/Braun, Kunststoff-Handbuch, vol. 3/1, Polycarbonate, Polyacetale, Polyester, Celluloseester, Carl Hanser Verlag, Munich, Vienna 1992, p. 118-145 as well as to EP-A 0 517 044.

In accordance with this process, phosgenation of an initially introduced disodium salt of a bisphenol (or a mixture of different bisphenols) is performed in aqueous/alkaline solution (or suspension) in the presence of an inert organic solvent or solvent mixture that forms a second phase. The oligocarbonates being produced, mainly in the organic phase, are condensed, with the aid of suitable catalysts, to give high molecular weight polycarbonates dissolved in the organic phase. The organic phase is then separated and the polycarbonate is isolated therefrom by a variety of working-up steps.

Diphenols that are suitable for the production of polycarbonates to be used in accordance with the invention are, for example, hydroquinone, resorcinol, dihydroxydiphenyl, bis-(hydroxyphenyl)-alkanes, bis-(hydroxyphenyl)-cycloalkanes, bis-(hydroxyphenyl)-sulfides, bis-(hydroxyphenyl)-ethers, bis-(hydroxyphenyl)-ketones, bis-(hydroxyphenyl)-sulfones, bis-(hydroxyphenyl)-sulfoxides, α,α′-bis-(hydroxyphenyl)-diisopropylbenzenes, and their alkylated, ring-alkylated and ring-halogenated compounds.

Preferred diphenols are 4,4′-dihydroxydiphenyl, 2,2-bis-(4-hydroxyphenyl)-1-phenylpropane, 1,1-bis-(4-hydroxyphenyl)-phenylethane, 2,2-bis-(4-hydroxyphenyl)-propane, 2,4-bis-(4-hydroxyphenyl)-2-methylbutane, 1,3-bis-[2-(4-hydroxyphenyl)-2-propyl]-benzene, (bisphenol M), 2,2-bis-(3-methyl-4-hydroxyphenyl)-propane, bis-(3,5-dimethyl-4-hydroxyphenyl)-methane, 2,2-bis-(3,5-dimethyl-4-hydroxyphenyl)-propane, bis-(3,5-dimethyl-4-hydroxyphenyl)-sulfone, 2,4-bis-(3,5-dimethyl-4-hydroxyphenyl)-2-methylbutane, 1,3-bis-[2-(3,5-dimethyl-4-hydroxyphenyl)-2-propyl]-benzene, 1,1-bis-(4-hydroxyphenyl)-cyclohexane and 1,1-bis-(4-hydroxyphenyl)-3,3,5-trimethyl-cyclohexane (bisphenol TMC) and mixtures of these.

Particularly preferred diphenols are 4,4′-dihydroxydiphenyl, 1,1-bis-(4-hydroxyphenyl)-phenylethane, 2,2-bis-(4-hydroxyphenyl)-propane, 2,2-bis-(3,5-dimethyl-4-hydroxyphenyl)-propane, 1,1-bis-(4-hydroxyphenyl)-cyclohexane and 1,1-bis-(4-hydroxyphenyl)-3,3,5-trimethylcyclohexane (bisphenol TMC) and mixtures of these.

These and other suitable diphenols are described in e.g. U.S. Pat. Nos. 2,999,835, 3,148,172, 2,991,273, 3,271,367, 4,982,014, and 2,999,846, in German patents 1 570 703, 2 063 050, 2 036 052, 2 211 956 and 3 832 396, French patent 1 561 518, in the monograph “H. Schnell, Chemistry and Physics of Polycarbonates, Interscience Publishers New York 1964, p. 28 et seq.; p. 102 et seq.”, and in “D. G. Legrand, J. T. Bendler, Handbook of Polycarbonate Science and Technology, Marcel Dekker, New York 2000, p. 72 et seq.”

In the case of homopolycarbonates, only one diphenol is used, in the case of copolycarbonates several diphenols are used, wherein obviously the bisphenols used, as also all other chemicals and auxiliary substances added for the synthesis, may be contaminated with impurities arising from their own synthesis, handling and storage procedures, although it is desirable to work with raw materials that are as clean as possible.

The monofunctional chain terminators required to control the molecular weight, such as phenol or alkyl phenols, in particular phenol, p-tert.butylphenol, iso-octylphenol, cumylphenol, their chlorinated esters or acid chlorides of monocarboxylic acids or mixtures of these chain terminators, are either added with the bisphenolate(s) to be used in the reaction or else at any other point in the synthesis, as long as phosgene or chlorinated carboxylic acid end groups are still present in the reaction mixture or, in the case of acid chlorides and chlorinated esters being chain terminators, as long as sufficient phenolic terminal groups are available on the polymers being produced. However, the chain terminator(s) are preferably added after phosgenation at a place or a time when phosgene is no longer present but the catalyst has still not been metered in, or they are metered in before the catalyst or either together with or in parallel with the catalyst.

Any branching agents or branching agent mixtures being used are added to the synthesis in the same way, but generally before the chain terminators. Trisphenols, quaternary phenols or acid chlorides of tri- or tetracarboxylic acids are generally used, or else mixtures of polyphenols or acid chlorides.

Some of the compounds with three or more phenolic hydroxyl groups that may be used are, for example
phloroglucine,
4,6-dimethyl-2,4,6-tri-(4-hydroxyphenyl)-heptene-2,
4,6-dimethyl-2,4,6-tri-(4-hydroxyphenyl)-heptane,
1,3,5-tri-(4-hydroxyphenyl)-benzene,
1,1,1-tri-(4-hydroxyphenyl)-ethane,
tri-(4-hydroxyphenyl)-phenylmethane,
2,2-bis-[4,4-bis-(4-hydroxyphenyl)-cyclohexyl]-propane
2,4-bis-(4-hydroxyphenyl-isopropyl)-phenol
tetra-(4-hydroxyphenyl)-methane.

Other suitable trifunctional compounds include 2,4-dihydroxybenzoic acid, trimesic acid, cyanuric chloride and 3,3-bis-(3-methyl-4-hydroxyphenyl)-2-oxo-2,3-dihydroindole.

Preferred branching agents are 3,3-bis-(3-methyl-4-hydroxyphenyl)-2-oxo-2,3-hydroindole and 1,1,1-tri-(4-hydroxyphenyl)-ethane.

The catalysts used in the phase interface process are tertiary amines, in particular triethylamine, tributylamine, trioctylamine, N-ethylpiperidine, N-methylpiperidine, N-i/n-propylpiperidine; quaternary ammonium salts such as tetrabutylammonium/tributylbenzylammonium/tetraethylammonium hydroxide/chloride/bromide/hydrogen-sulfate/tetrafluoroborate; as well as the phosphonium compounds corresponding to these ammonium compounds. These compounds are described in the literature as typical phase interface catalysts, are commercially available and are familiar to a person skilled in the art. The catalysts may be added to the synthesis individually, as a mixture or else alongside each other or in sequence, optionally also before phosgenation, but preferably are metered in after the introduction of phosgene, unless an onium compound or mixture of onium compounds is used as catalyst, when addition prior to the introduction of phosgene is preferred. The catalyst(s) may be metered in in bulk, in an inert solvent, preferably the one used for polycarbonate synthesis, or else as an aqueous solution, in the case of tertiary amines this then takes place in the form of their ammonium salts with acids, preferably inorganic acids, in particular hydrochloric acid. When using several catalysts or when portions of the total amount of catalyst are metered in, naturally different modes of metering may take place at different places or at different times. The total amount of catalyst used is between 0.001 and 10 mol. %, with respect to the moles of bisphenols used, preferably 0.01 to 8 mol. %. particularly preferably 0.05 to 5 mol. %.

In addition, the production of polycarbonates from diaryl carbonates and diphenols using the well-known polycarbonate process in the melt, so-called melt transesterification, is also possible, as described e.g. in WO-A 01/05866 and WO-A 01/05867. In addition, transesterification processes (acetate process and phenyl ester process) are described, for example, in U.S. Pat. Nos. 3,494,885, 4,386,186, 4,661,580, 4,680,371 and 4,680,372, in EP-A 26 120, 26 121, 26 684, 28 030, 39 845, 91 602, 97 970, 79 075, 14 68 87, 15 61 03, 23 49 13 and 24 03 01 as well as in DE-A 14 95 626 and 22 32 977.

The following examples explain the invention but do not restrict its scope.

### EXAMPLES

### Method for the Determination of the Fluorescent Particle Content in Polycarbonate

Analysis for the content of fluorescent particles is performed by filtration of the polycarbonate sample concerned (50 g), dissolved in dichloromethane (LiChrosolv; Merck: 1.06044 K33506244 430) (700 ml), through a Teflon filter membrane (Bohlender GmbH, D-97847, Grünsfeld) with a 5 μm pore diameter and a filter membrane thickness of 1 mm. The filter discs are dried under vacuum and protected from surrounding dust by a covering. After filtration, the filter surface is studied (scanned) using a fluorescence microscope, an Axioplan 2 from Zeiss AG, Germany. An excitation wavelength of 400-440 nm, an illumination time of 40 ms per scan and 25 fold total magnification are used. The fluorescent particles are detected and the data is evaluated using image processing software (KS 300 3.0 from Zeiss AG). Only particles with a characteristic color are counted, i.e. other particles such as dust are not taken into account (determined by the HIS color model, see above). The color parameters for detecting fluorescent particles are set so that they are equivalent to the parameters of particles found below surface defects in optical discs. The surface of the filter is scanned automatically using a computer-controlled object table (Zeiss AG).

In this way, and under the conditions cited above (wavelength, total magnification, illumination time), a coherent fluorescing region on the Teflon filter is automatically detected and counted as 1 count. The individual fluorescent particles that are found on the Teflon filter are counted. The total number of fluorescent particles is divided by the weight of the polycarbonate melt weighed out in the individual mixture and this gives the number of particles (fluorescent) with respect to 1 gram of polycarbonate (counts/g).

An aromatic polycarbonate based on bisphenol A and tert.butylphenol as chain terminator with a melt volume rate MVR=71 cm³/10 min (at 300° C.; 1.2 kg) was used as the test material.

The polycarbonate granules, pre-dried at 120° C. in a vacuum drying cabinet, are melted at different temperatures in an extruder (Brabender 35/17D, Karg Industrietechnik, 82152 Krailling), with data processing/evaluation Plasti-Corder PL2000 vers. 2.6.9, and processed with different throughputs. The melt is filtered on the one hand using the process according to the invention and on the other hand using a conventional filtration process (comparison).

### Example 1

### Comparison Example—0 Sample—No Filtration

The polycarbonate mentioned above is melted in an extruder (see above). The heating system for the individual heating zones is set at 305° C. (zone 1), 310° C. (zone 2) and 315° C. (zone 3). At the start, the extruder is purged for 3 minutes at a throughput of 6 kg/h. Then the throughput is reduced to 1.2 kg/h and flushed through for 15 minutes at this throughput. The temperature of the polymer melt at the die plate is about 295-305° C. A sample is taken from the polymer melt.

The number of fluorescent particles in the polycarbonate obtained in this way is determined using the method described above. The result gives 15.2 counts/g of fluorescent particles and thus a high value for the number of fluorescent particles.

### Example 2

### Comparison Example, with 25 μm Filter

The test in example 1 was performed, but a melt filter was used upstream of the die plate. For this purpose, a thin-layered stainless steel filter (thickness on average 30 μm; wire diameter about 10 μm), wherein the supporting gauze had been removed, i.e. only the filter membrane was used, a circular piece with a diameter of 41.2 mm being cut out. The pore size in the filter was 25 μm. In the direction of flow of the polymer, first this filter membrane, then a supporting gauze (expanded metal with a mesh size of 0.5×1.2 mm 2), followed by a supporting ring with wire gauze with a mesh size of 1.2 mm² and then a perforated plate with holes of 2.2 mm were installed. Then the die plate was installed and fixed in place with a cap nut. The diameter of the active filtration area is 30 mm. Using this setup ensures that the filter is supported, i.e. is not damaged, and covering is achieved.

The polymer granules are melted under the conditions described above. Melt samples are taken after 35 minutes and after 60 minutes (reckoned from the time of installation of the filter). The first sample, after 35 minutes, had a fluorescent particle content of 7.8 counts/g. The second sample after 60 minutes had a value of 8.3 counts/g. The pressure upstream of the filter was about 1 bar. This result demonstrates that incorporation of the filter mentioned above reduces the number of fluorescent particles only slightly.

### Example 3

### Comparison Example

The test in example 1 was performed, but a melt filter was inserted into the die plate. For this purpose, a stainless steel non-woven structure made from the material with material number 1.4571 was used. The non-woven structure consisted of 2 layers. In the direction of flow of the melt, the sequence was first a less dense layer with a thickness of 0.15 mm. The pore size of the less dense layer was on average 30 μm. The more dense layer was connected to the less dense layer and had a thickness of 0.15 mm. The pore size of the more dense layer was on average about 10 μm. The metal fibres had a diameter of about 5-7 μm. The thickness of the filter was 0.3 mm in total. The diameter of the non-woven filter structure was 28.4 mm. The non-woven filter structure is the first layer in the sequence in the direction of flow of the polymer melt. Following this are installed a support gauze (expanded metal with a mesh size of 0.5×1.2 mm²), then a support ring with a wire gauze with a mesh size of 1.2 mm and then a perforated sheet with holes of 2.2 mm. Finally the die sheet is installed and fixed in place with a cap nut. Using this setup ensures that the filter is supported, i.e. is not damaged, and covering is achieved. The diameter of the active filtration area is 19 mm. The polymer granules are melted under the conditions described above. After 25 minutes (reckoned from the time of insertion of the melt filter) a sample is taken from the polymer melt. The pressure upstream of the non-woven filter structure is 55-60 bar.

The number of fluorescent particles in the polycarbonate obtained in this way is determined using the method described above.

Evaluation gave 8.7 counts/g.

This shows that under conditions that are outside the conditions in accordance with the invention, effective separation of the fluorescent particles is possible to only an unsatisfactory extent.

### Example 4

### According to the Invention, After Insertion of the Filter

The test in example 1 was performed, but a melt filter was inserted into the die plate. The metal non-woven structure had the same structure as described in example 3. However, the diameter of the non-woven filter structure was 41.2 mm. The diameter of the active filtration area was 30 mm. The polymer granules are melted under the conditions described above. After 25 minutes (reckoned form the time of insertion of the melt filter), the first sample is taken, and a second sample is taken after a further 25 minutes. The pressure upstream of the non-woven filter structure is 20-25 bar.

The number of fluorescent particles in the polycarbonate obtained in this way is determined using the method described above.

Evaluation of the first sample gave 1.56, that of the second sample 1.18 counts/g, of fluorescent particles.

This demonstrates that the method for melt filtration according to the invention leads to a clear reduction in the number of fluorescent particles in the polymer melt.

### Example 5

### According to the Invention, with a Passivated Filter

The test in example 1 is performed, but the melt filter is first conditioned for 24 hours at 350° C. in a circulating air oven. The filter is inserted in the way described in example 4. The polymer granules are melted under the conditions given above A sample is taken after 3 hours.

Evaluation of the sample gave 0.47 counts/g of fluorescent particles.

The advantages of the filtration method according to the invention can be seen quite clearly from the significantly lowered number of fluorescent particles.

What is claimed is:

1. A process for purifying polycarbonate comprising obtaining molten polycarbonate having weight average molecular weight of 14,000 to 30,000 g/mol and filtering said polycarbonate through at least one non-woven metal structure having a thickness of 5 to 0.1 mm, said structure including at least one dense layer, and at least one less dense layer wherein said dense layer is 0.05 to 0.2 mm thick and has pore size of 1 to 10 μm to obtain polycarbonate.

2. The process of claim 1 wherein said structure includes 2 to 10 layers.

3. The process of claim 1 wherein said thickness is 1 mm to 0.2 mm.

4. The process of claim 1 wherein said dense layer includes wires having diameters of 1-20 μm.

5. The process of claim 1 wherein said less dense layer is 0.05 to 0.3 mm thick.

6. The process of claim 5 wherein the less dense layer has pore size of 0 to 60 μm.

7. The process of claim 1 carried out under pressure of 5 to 35 bar, at temperature of 220 to 400° C.

8. The process of claim 1 wherein said metal is stainless steel.

9. The process of claim 1 wherein the metal is thermally pretreated in an oxidative atmosphere.

10. The process of claim 9, wherein the metal is pretreated for 4 to 35 hours at temperatures of 300 to 400° C.

11. A process for purifying polycarbonate comprising obtaining molten polycarbonate having weight average molecular weight of 14,000 to 30,000 g/mol and filtering said polycarbonate through at least one non-woven metal structure having a thickness of 5 to 0.1 mm, said structure including at least one dense layer, and at least one less dense layer wherein said dense layer is 0.05 to 0.2 mm thick and has pore size of 1 to 10 μm to obtain polycarbonate wherein content of fluorescing particles is lower than that in the molten polycarbonate.
